(19) United States
(12) Patent Application Publication
(10) Pub. No.: US 2004/0028137 A1
(43) Pub. Date: Feb. 12, 2004

(54) Motion detection camera

(76) Inventors: Jeremy Wyn-Harris, (US); Stephen Arthur Hooker, Te Awamutu (NZ)

Correspondence Address: Michael Molins, Molins & Co., Level 25 Chifley Tower, Sydney, 2000, AU

(21) Appl. No.: 10/459,500

(22) Filed: Jun. 12, 2003

Related U.S. Application Data
(60) Provisional application No. 60/390,154, filed on Jun. 21, 2002.
(60) Provisional application No. 60/389,666, filed on Jun. 19, 2002.
(60) Provisional application No. 60/390,087, filed on Jun. 21, 2002.

(51) Int. Cl. H04N 7/12

(52) U.S. Cl. 375/240.17; 348/699

(57) ABSTRACT

A computationally inexpensive method for determining motion in a digital image stream is disclosed. The method and its software implementation provide good performance in changing light conditions and are achieved by using gradient information between adjacent areas. This gradient is normalised using the intensity or color value of the two areas, such that changing light conditions do not affect the result. The algorithm may be set up include or exclude portions of the view scene.

### BACKGROUND

The present invention relates generally to digital video images, and specifically to the detection of motion within successive digital image frames.

A digital video camera has hardware and software to collect and save a sequence of video images as a sequence of frames, each of which is comprised of “picture elements”, or “pixels”, that is, an array of points each having a color value. A single frame may comprise many thousands of such pixels, and a typical camera has a frame rate of 10-30 frames per second or more. Such cameras are used for a variety of purposes including manufacturing, security, recreation, documentation and presentation, and others. In some of these applications, a fixed camera is used to provide a continuous image of a scene, for example, a camera fixed on a passageway to show the pedestrian traffic through the passageway. In many cases, the fixed scene is of interest only when it changes, that is, when there is motion detected within the view of the camera. This allows the images of the fixed scene to be discarded until motion is detected, after which, the images are collected and saved, for example, to an optical storage device (compact disk or digital video disk), until motion is no longer detected.

Simple motion detection algorithms for digital application typically compare pixels from frame to frame (frame differencing). Motion is detected when a number of pixels exceed a certain threshold between selected frames. This method is cumbersome, crude and susceptible to give false results under exposure and lighting changes.

More complex motion detection algorithms attempt to identify various objects in the scene. If the objects move then motion can be easily detected, even in changing light conditions. However these algorithms are usually very complex and impractical for limited-resource (memory and processing power) applications such as in a small digital camera.

In addition, some scenes and applications will give a motion detection signal for portions of the scene which is of no interest to the user of the camera. For example, a scene of the exterior entrance to a building may have a flag in the background. A positive motion detection signal is desired only when a pedestrian approaches the building entrance, and not when the flag moves.

Also, current motion detection processes will signal (falsely) motion detection when lighting conditions change. Consider again a camera fixed on a building exterior. Current motion detection processes will give a positive motion detect when a cloud moves in front of the sun changing the shadows of fixed objects in the camera scene.

What is needed is hardware, software and methods for detecting motion in a digital camera which is simple—capable of processing frames at the camera's frame-rate—and reliable. It is therefore an object of the present invention to provide such a simple, reliable method for motion detection. It is another object of the present invention to allow motion detection to be chosen or not for sections of the camera view scene. It is still another object of the present invention to provide reliable motion detection under changing light conditions.

### SUMMARY OF THE INVENTION

A computationally inexpensive solution that provides good performance in changing light conditions is achieved by comparing gradient information from the same cells of successive frames. A cell is a sub-division of a block. A block is a sub-division of a frame. This gradient of a cell is normalised using the color value or intensity of the cell, such that changing light conditions do not affect the result. Motion is detected when the difference in gradient between the same cell in successive frames exceeds a threshold. The threshold value can be varied to give reliable results under a wide range of light conditions. The algorithm may be set up include or exclude portions of the view scene according to a number of factors.

For the purposes of calculation, each frame is divided into a number of rectangular blocks. Blocks may be included or excluded from the calculation by the user. For example, the block containing the flag may be user excluded during camera configuration, while the block containing the building entrance is included. Blocks are divided into cells. Cells are comprised of pixels. A “gradient” is calculated for each cell using a simple calculation. The gradient for each cell is stored and compared to the gradient for the same cell in the subsequent frame. If the difference between the two gradients exceeds a numeric threshold, motion is deemed to be detected.

The present invention included techniques for optimizing the efficiency of the motion detection in a number of ways, including:

dynamically excluding cells, for example, when overexposed or underexposed

dynamically altering the number of cells within each block, where increasing the number of cells gives better motion detection, and decreasing the number of cells increases the calculation speed because there are fewer inter-frame comparisons

dynamically setting the gradient difference threshold to minimize false motion detection signals

### BRIEF DESCRIPTION OF THE DRAWINGS

FIG. 1 illustrates image division into blocks

FIG. 2 illustrates block division into cells and pixels

FIG. 3 illustrates a gradient calculation and inter-frame comparison

### DETAILED DESCRIPTION

A digital video camera captures images as successive frames of data, each frame comprising an array of color or black and white points or “pixels”. The frames may be collected and stored, or discarded. If stored, they are available for viewing, printing, transferring to other media, or other use.

Each pixel has a color value in one of a number of encoding conventions. For example, some cameras collect “red-green-blue” intensities on a numeric range of 0 to 255. In the present invention, the camera has an on-board processor capable of examining individual pixels in a frame, and has intermediate storage for non-pixel information. Such a camera is able to not only collect images, but make decisions based on the image content. In such a camera, the image for the current instant is collected and resides in a video image buffer, available to the on-board processor.

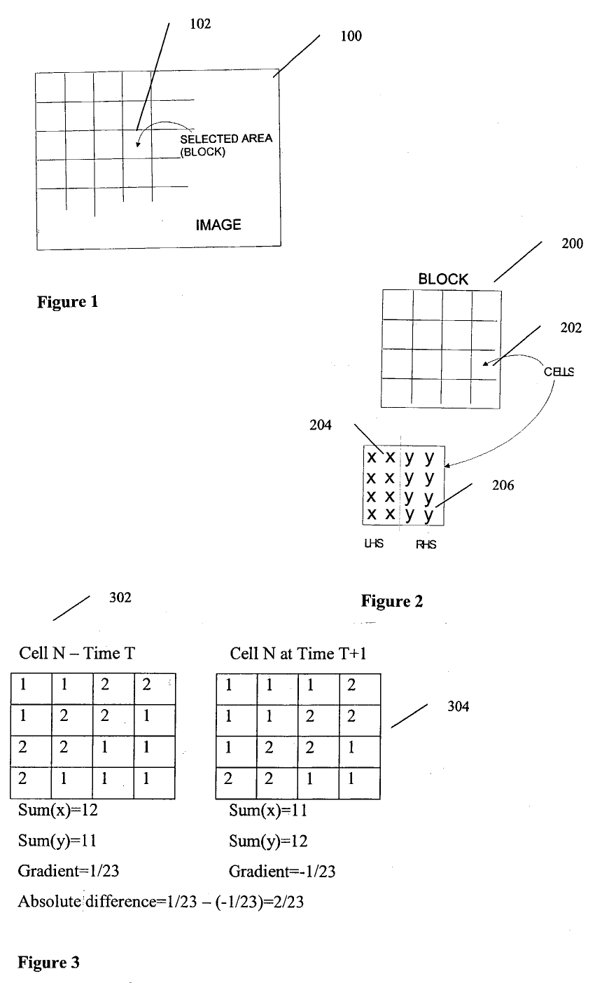

A camera “frame” refers to the image at an instant of time. Consecutive images are separated in time according to the camera's “frame rate”. Frames are divided into a rectangular array of “blocks” which are preferably but not necessarily of equal sized and cover the frame. Blocks are divided into a number of equal-sized “cells”. Cells contain “pixels” which have a color value. For black and white images, the color value is a number giving the shade of grey between black and white. If the image is color, the color value is an expression of the one or more of the composite colors (for example, red, green, blue) of the pixel. Referring now to FIG. 1. This illustrates a video frame 100 in the video buffer. The image frame 100 is comprised of an array of rectangular blocks 102.

Referring now to FIG. 2. This illustrates a single rectangular block from a video frame, for example block 102 from FIG. 1. Each block is sub-divided into a number of cells. Each cell preferably has the same number of pixels. Each cell is further sub-divided into a left hand side 204 and a right hand side 206, containing the same number of pixels. Individual pixels are shown as “x” on the left hand side 204 and “y” on the right hand side 206.

The normalised gradient for each cell within a block is calculated by the following equation:

$${gradient}_{cell} = \frac{\sum {colorvalue}_{x} - \sum {colovalue}_{y}}{\sum {colorvalue}_{x} + \sum {colorvalue}_{y}} \qquad Formula 1$$

The gradient is the difference between the total of the left and total of the right color values normalised or divided by the sum of the color values of both sides.

The gradient is stored for each cell, and then compared to the gradient for the same cell in the next frame. Motion within a cell is detected if the absolute difference between the gradients exceeds a certain threshold. That is,

|gradientₜᵢₘₑ₁−gradientₜᵢₘₑ₂|>Motion Threshold

Formula 2

Referring now to FIG. 3. This illustrates a simple application of the above algorithm. A single cell is shown in time “T” 302 and time “T+1” 304. The values shown are the color value (1 or 2) of the 16 pixels that comprise the cell. At time T, the sum of the left and right halves of the cell are 12 and 11 respectively, giving a gradient of (12−11)/(12+11)=1/23. At time T+1, the gradient is (11−12)/(11+12)=−1/23. The absolute difference between the two gradients is thus 2/23. Thus in the example of FIG. 3, if the threshold is set less than or equal to 2/23, then motion is deemed to be detected.

In its simplest form, the camera has a fixed number of blocks, with a fixed number of cells in each block. The calculation of Formula 1 is done over each cell and saved for comparison, and the comparison of Formula 2 is done for the saved and calculated gradients. If any comparison gives an absolute difference greater than the motion threshold, motion is detected and triggered. The motion detection trigger is detected by other processes of the camera to do work with the images. For example, the images may be ignored until motion is detected, then saved, displayed, or transmitted until motion is no longer detected.

The efficiency of the process of Formula 1 and Formula 2 may be increased in a number of ways by varying the number of blocks to calculated, the number of cells in each block, and the motion threshold. These may be done manually by the user of the camera, or may be set dynamically by the logic of the camera. When done manually by the user, the camera is connected to a computer with a display screen. The connection is through one of the standard connection ports of the computer, for example a USB or serial port. While connected, images may be transferred from the camera to the computer for display, and configuration parameters may be downloaded from the computer to the camera. In the alternative the camera may be configured by a remote user by allowing the camera to connect with a configuration server and also providing the user with access to the configuration server. In this way the user's client can be served forms or applications which are interpreted by the server and turned into configuration commands which are served to the camera when the camera is connected to the configuration server.

The number of blocks may be altered to give finer or grosser coverage of the image area and allow the user to better control which areas of the image are of interest. While the number of blocks may be pre-set, for example during camera manufacture, it may also be changed. This is done by allowing the user of the camera to view one or more camera images in a software application with superimposed lines showing the blocks. By increasing or decreasing the number of blocks, or resizing the blocks or selecting or de-selecting blocks, the user may refine the coverage of the image area. The user may thus indicate blocks to ignore for purposes of motion detection. As the camera image is displayed with superimposed block lines, the user indicates, for example with the computer mouse, blocks to ignore. The number, size shape and location of blocks and the blocks to ignore are then downloaded to the camera or configuration server where this information is used to establish the image processing parameters and routines.

During processing, blocks may be dynamically included or excluded based on over- or underexposed images. Such blocks may give a false motion detection result due only to changes in light intensity. For example, a camera with an image field of a dark room containing a chair will indicate motion when the light in the room is gradually turned up so that the chair becomes visible. Similarly overexposed blocks may trigger false motion detection when the light dims and objects become visible. The solution to this problem is to examine the data used to calculate the gradient. If a significant amount of the input data either falls under a low-end threshold (in that the cell contains a significant number of low color values) or above a high-end threshold (in that the cell contains a significant number of high color values), then the gradient is not calculated for that particular cell. Such cells are added to the list of cells omitted in the calculation of Formula 1. The cells of each such ignored block are examined in each frame and ignored or included in the calculation of Formula 1 based on the number of low or high color values. In other words, a cell is ignored only as long as it is over- or underexposed.

The number of cells per block is a critical element in effectiveness and efficiency of the method of the present invention. More cells per block give a better result as it provides a more resolution in the detection of motion; fewer cells per block give a faster calculation of the comparisons. The camera will set a number of cells per block to maximise motion detection within the frame rate of the camera. The cells per block are pre-set to a default number. The user sets the number of blocks to process as described above. The user then also declares which blocks if any are to be ignored in the calculation. This process uses one or more images from the camera. The result of this process is a number of process parameters downloaded to the camera. The camera then will perform motion detection on two successive sample images from the camera using the default number of cells per block, on the number of blocks in the process parameters, and will note the time taken by the calculations. If the calculation time is shorter than a set percentage of the frame-rate, then the same calculation is done with more cells per block. Similarly, if the calculation time is longer than the set percentage of the frame rate, then the calculation is done with fewer cells per block. This process is repeated until the number of cells is the maximum that can be processed. A set percentage of the frame rate is used rather than the total frame rate since other processing must be done within the frame rate, not just the motion detect calculation. Since blocks may be included or excluded during processing as described above, the number of cells per block will have to be recalculated whenever the number of blocks to process changes.

To prevent the camera from incorrectly reporting detection of motion due to changing exposure levels of the imaging device, the threshold of motion detection is made a function of the exposure of the camera. The exposure is a function of both the frame rate and the camera aperture setting, the “f-stop”. When either the frame rate or aperture changes, the threshold of Formula 2 is changed. For an increase in exposure time (lower frame rate) or aperture, the threshold value is increased. For a decrease in exposure time (faster frame rate), the threshold value is decreased

Thus, in one example, the camera implementing this method of motion detection takes the following steps:

1. The sub-division of the image into blocks is determined by the user and downloaded to the camera.

2. Information regarding the blocks and the blocks to be ignored are determined and are communicated to the camera.

3. The cells per block are determined by running Formula 1 on sample images, and adjusting the number of cells per block until an optimal value is found.

4. The motion detection threshold is determined and set. This is a function of the frame rate and aperture of the camera.

5. Other processing options are determined or set. These include the horizontal, vertical, or “both” orientation of the cells within the blocks, using the black and white or color values of the image, and if color is used, selection of red, blue, green, or combination. These may be a factory setting or may be determined and set by the user using the computer and are downloaded to the camera.

6. Once the above settings and options are downloaded to the camera is ready to collect images and detect motion.

7. The motion detection process takes the following program steps:

Collect the first image
Do forever

Divide the image into N blocks
For each of the N blocks

If the block is to be processed

For each cell

Divide cell into left / right and/or up / down
Calculate gradient (Formula 1)
If first image

Save gradient

Else

If overexposed or underexposed

Ignore cell

Else

Compare with corresponding saved gradient
If difference greater than threshold

Trigger motion detect
Exit

Endif
Endif
Save gradient

Endif

Next cell

Endif

Next block
Recalculate threshold
Mark any block or cell to ignore in next calculation
If any block or cell so marked

Recalculate cells per block

Enddo

Thus consecutive images are compared and motion is detected and processed if necessary. The threshold value is recalculated if necessary. The blocks to process or ignore for the next image are determined if necessary. The number of cells per block is calculated if necessary to have the optimum value.

The result is a very high-speed calculation for motion detection which minimizes the triggering of false motion detection due to:

1. Motion in undesired sections of the image

2. Objects “appearing” or “disappearing” due to changes in lighting

The motion detection process may also be optimised for horizontal (by choosing left/right division), or vertical motion (by choosing up/down division), or for any motion (by using both divisions), and for black and white or color images. One or more parts of each image may be ignored for purposes of motion detection, and this may be either statically or dynamically determined, for example, when an overexposed or underexposed condition is detected. The sensitivity of the process is a function of the number of cells examined, and this number may be statically or dynamically determined. The threshold for triggering a motion detected event may also be statically or dynamically determined.

In practice, a number of the above processes may be omitted in different models, allowing for a range of cameras offering different desirable features. For example, the low-end model may use all factory-set values for number of blocks, cells, and threshold values, while a high-end model may provide the dynamic calculation of these values.

The process is described as for a digital camera, but this description does not preclude the use of the technique for other types of digital images.

What is claimed is:

1. A method for detecting motion in an area, from first and second digital images of that area, comprising the steps of:
identifying in a first image, at least one cell and determining a cell gradient value by:
subdividing a first cell into first and second halves having equal numbers of pixels;
obtaining for each pixel, a value;
adding the values in the first half to reach a first sum;
adding the values in the second half to reach a second sum;
subtracting the first and second sums to calculate a difference;
adding the first and second sums to calculate a denominator;
dividing the difference by the denominator to result in the first cell gradient value;
identifying the first cell in the second image and determining a second cell gradient value in accordance with the steps for determining the first cell gradient value;
obtaining an absolute difference between the first and second cell gradient values to produce a motion index;
comparing the motion index to a threshold value, so that motion is deemed to have occurred when the index equals or exceeds the threshold value.

2. The method of claim 1, wherein:
the images are sub-divided into blocks and the blocks are subdivided into cells;
the blocks being user selectable or excludable.

3. The method of claim 1, wherein:
the rate of the comparison of the motion index to the threshold value occurs at a rate comparable to a frame rate of a camera which both produced the first and second images and which supplies those images to a processor which performs the steps of claim 1.

4. The method of claim 3, wherein:
the rate of comparison is optimised by adjusting the number of cells in a frame according to any one of: the color values in a cell, the frame rate, the exposure or integration time, the f-stop of the camera.

5. The method of claim 1, wherein:
the halves are arranged horizontally or vertically within a cell according to user selection.

6. The method of claim 1, where:
the method is performed twice;
once when the cell halves are oriented horizontally and a second time when the cell halves are oriented vertically, the comparison of motion index and threshold value being performed once for each orientation.

7. Software for detecting motion in an area, from inputs comprising first and second digital images of that area, comprising program steps for:
identifying in a first image, at least one cell and determining a cell gradient value by:
subdividing a first cell into first and second halves having equal numbers of pixels;
obtaining for each pixel, a value;
adding the values in the first half to reach a first sum;
adding the values in the second half to reach a second sum;
subtracting the first and second sums to calculate a difference;
adding the first and second sums to calculate a denominator;
dividing the difference by the denominator to result in the first cell gradient value;
identifying the first cell in the second image and determining a second cell gradient value in accordance with the steps for determining the first cell gradient value;
obtaining an absolute difference between the first and second cell gradient values to produce a motion index;
comparing the motion index to a threshold value, so that motion is deemed to have occurred when the index equals or exceeds the threshold value.

8. The software of claim 7, further comprising program steps wherein:
the images are sub-divided into blocks and the blocks are subdivided into cells;
the blocks being user selectable or excludable.

9. The software of claim 8, further comprising program steps wherein:
the rate of the comparison of the motion index to the threshold value occurs at a rate optimised to a frame rate of a camera which both produced the first and second images and which supplies those images to a processor which performs the steps of claim 1.

10. The software of claim 9, wherein:
the rate of comparison is optimised by adjusting the number of cells identified in a frame according to any one of: the color values in a cell, the frame rate, the exposure or integration time, the f-stop of the camera.

11. The software of claim 1, wherein:
the halves are arranged horizontally or vertically within a cell according to user selection.

12. The software of claim 1, having program steps for providing that:
the comparison is performed twice;
once when the cell halves are oriented horizontally and a second time when the cell halves are oriented vertically, the comparison of motion index and threshold value being performed once for each orientation.

13. The software of claim 7, further comprising program steps for:
interpreting configuration instructions from a user, those instructions allowing the establishment of one or more parameters selected from the group of: frame size, frame rate, block size, block location, number of cells in a block, orientation of cell halves, exposure or integration time, color or black and white images, or further software steps to perform if motion is detected.

14. The software of claim 7, wherein:
program steps are provided for temporarily adjusting the threshold value according to color values of the pixels in a frame.
